(19) United States
(12) Patent Application Publication
(10) Pub. No.: US 2010/0333151 A1
(43) Pub. Date: Dec. 30, 2010

(54) CROSS PLATFORM ENTERTAINMENT ARCHITECTURE

(75) Inventor: Wen Huang, Los Angeles, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: GEMSTAR DEVELOPMENT CORPORATION, Santa Clara, CA (US)

(21) Appl. No.: 12/495,592

(22) Filed: Jun. 30, 2009

(51) Int. Cl. H04N 7/173; H04N 7/26

(52) U.S. Cl. 725/94; 375/240.25; 348/441; 375/E07.027; 348/E07.003

(57) ABSTRACT

A broadcast video platform that includes a first communications interface, a second communications interface, and a decoder. The first communications interface is coupled to a broadcast-based user equipment device and is configured to receive a request for a video item from the user equipment device according to a first transport protocol. The second communications interface is coupled to a server and configured to provide to the server the request according to a second transport protocol and to receive the video item in binary format. The decoder is configured to decode the requested video item.

### FIELD OF THE INVENTION

The invention relates generally to entertainment architectures and, more particularly, to a cross-platform system and method for delivering media assets to heterogeneous broadcast television infrastructures.

### SUMMARY OF THE DISCLOSURE

Embodiments of the invention relate to a broadcast video platform that may include a first communications interface, a second communications interface and a decoder. The first communications interface may be coupled to a broadcast-based user equipment device and may be configured to receive a request for a video item from the user equipment device according to a first transport protocol. The second communications interface may be coupled to a server and may be configured to provide to the server the request according to a second transport protocol and to receive the video item from the server in binary format. The decoder may decode the requested video item.

Other embodiments of the invention relate to a server that includes a processor and a storage device connected to the processor where the storage device is encoded with instructions. The instructions, when executed by the processor, may include receiving a request for an video item, where the request is expressed as an XML listing in a SOAP envelope. The SOAP envelope may include a header section and a body section, where the body section may include an identifier corresponding to a user equipment device used to request the video item. The instruction may also include encoding the video item into a binary format and transmitting the video item in a SOAP envelope.

Other embodiments relates to a content management system that includes a content repository, a server, a buffer manager, and a web service module. The content repository may be configured to store a video item. The server may be configured to receive and respond to a request for the video item from a requesting entity. The buffer manager may be configured to segment the video item based on a buffer management policy that corresponds to a second buffer management policy associated with the requesting entity. The web service module may be configured to facilitate communication between the requesting entity and the server.

Others embodiments of the invention may relate to a system that includes a processor and a storage device connected to the processor where the storage device is encoded with instructions. The instructions, when executed by the processor, may include rendering a plurality of program listings for display to a user, wherein the program listings include a broadcast content item and an Internet content item; and receiving a request for the Internet content item, wherein the request conforms to the SOAP protocol.

Other embodiments of the invention relate to a method including receiving a request for a video item from the user equipment device according to a first transport protocol, providing the request to a server according to a second transport protocol, receiving the video item from the server in a binary format, and decoding the video item.

Other embodiments relate to a system including means for receiving a request for a video item from the user equipment device according to a first transport protocol, means for providing the request to a server according to a second transport protocol, means for receiving the video item from the server in a binary format, and means for decoding the video item.

### BRIEF DESCRIPTION OF THE DRAWINGS

The above and other aspects and advantages of the invention will become more apparent upon consideration of the following detailed description, taken in conjunction with the accompanying drawings, in which like reference numerals refer to like parts throughout, and in which:

FIG. 1 is an illustrative grid display of program listings arranged by time and channel in accordance with an embodiment of the invention;

FIG. 2 is an illustrative mosaic display that includes selectable options for organizing media content information according to an embodiment of the invention;

FIG. 3 shows an exemplary user equipment device according to an embodiment of the invention;

FIG. 4 is a simplified functional block diagram of an environment for practicing an embodiment of the invention;

FIG. 5 is an exemplary system for practicing facilitating access to Internet content from a broadcast network according to an embodiment of the invention;

FIG. 6 is a schematic diagram that illustrates an Internet content repository according to an embodiment of the invention;

FIG. 7 is a schematic diagram that illustrates a gateway according to an embodiment of the invention;

FIG. 8 is an exemplary method for collecting and aggregating Internet content according to an embodiment of the invention; and

FIG. 9 is an exemplary method for delivering Internet content to broadcast-based user equipment according to an embodiment of the invention.

### DETAILED DESCRIPTION OF EMBODIMENTS

Embodiments of the invention relate to a cross-platform system and method for delivering media assets to a broadcast video infrastructure, such as a broadcast video software platform or a broadcast-based user equipment device. One embodiment incorporates web technologies to facilitate cross-platform interaction between, for example, a broadcast video platform and a web server, where the web server is coupled to an Internet content source. Other embodiments relate to a broadcast video infrastructure that receives a request for an Internet content item according to a first transport protocol and forwards the request according to a second transport protocol. By coupling a broadcast video infrastructure with an Internet content delivery system, users of broadcast-based user equipment devices, such as a television, may be able to access Internet content (e.g., streaming video) without an Internet connection.

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content, and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

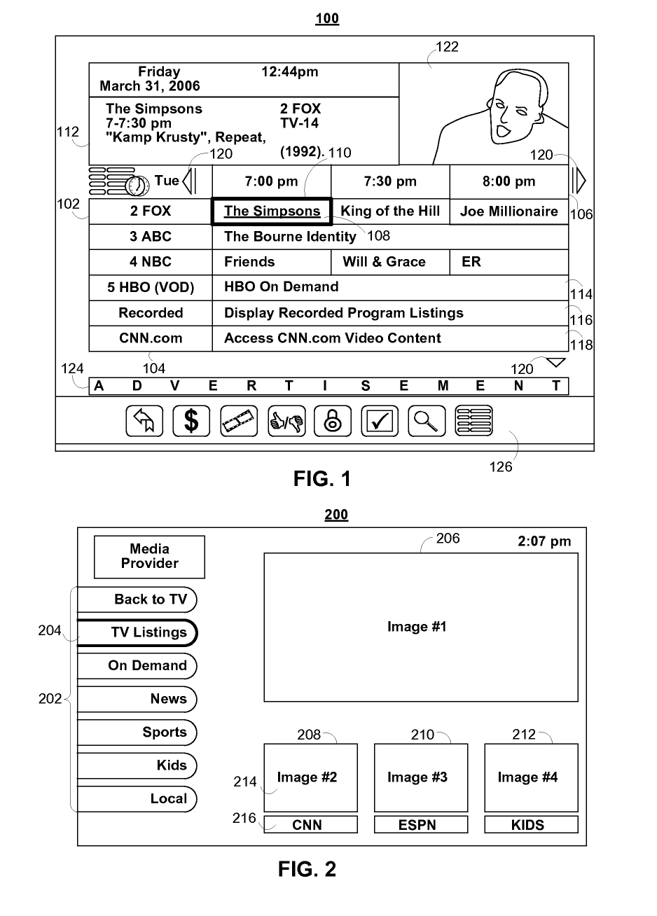

One of the functions of the media guidance application is to provide media listings and media information to users. FIGS. 1-2 show illustrative display screens that may be used to provide media guidance, and in particular media listings. The display screens shown in FIGS. 1-2 and may be implemented on any suitable device or platform. While the displays of FIGS. 1-2 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

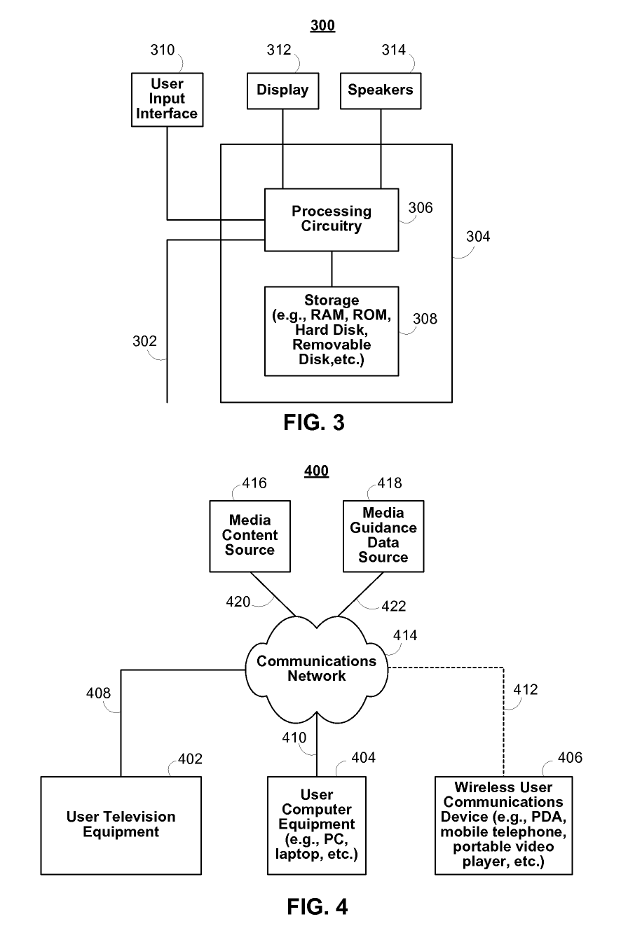

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions), ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

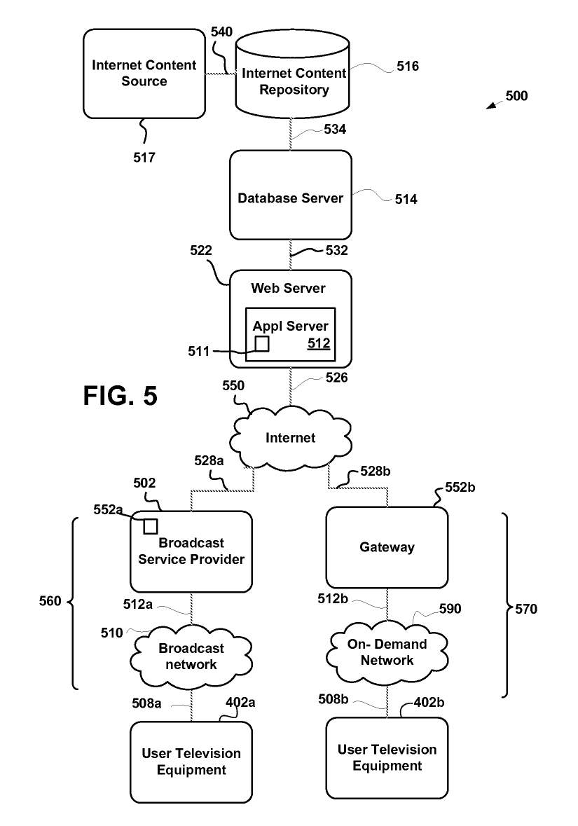

FIG. 5 shows a simplified functional block diagram of a system 500 for delivering Internet content to heterogeneous broadcast infrastructures according to an embodiment of the invention. System 500 includes user television equipment devices 402a and 402b coupled to respective broadcast video service provider infrastructures 560 and 570 via communication paths 508a and 508b. Broadcast infrastructures 560 and 570 are, in turn, coupled to an Internet 550 via communication paths 528a and 528b. Internet 550 is coupled, via a communication path 526, to a web server 522 running an application server 512 and a web service 511. In the illustrated embodiment, web server 522 is coupled to a database server 514 via communication paths 532. Database server 514, content repository 516, and Internet content source 517 are shown serially coupled via communication paths 534 and 540. Broadcast infrastructure 560 includes a broadcast service provider 502 and a gateway 552a coupled, via communication path 512a, to a broadcast network 510. Broadcast infrastructure 570 includes gateway 552b coupled to an on-demand network 590 via communication path 512b.

According to an embodiment, broadcast infrastructures 560 and 570 may manage distribution of media content to user television equipment 402a and 402b. For example, web service 511 may be configured to receive and process a request for an Internet content item available from Internet content repository 516. In one embodiment, web service 511 may facilitate interaction between web server 522 and broadcast infrastructure 560 via gateway 552a. In another embodiment, web service 511 may facilitate interaction between web server 522 and user broadcast infrastructure 570 via gateway 552b. By incorporating cross-platform web technologies, requests for Internet content may be processed by web service 511 irrespective of the software platforms employed by broadcast infrastructures 560 and 570.

Internet content source 517 may include Internet content providers including, for example, one or more distributors of Internet content that obtain rights to distribute video content from content owners (e.g., an Internet provider of video content of broadcast programs for downloading) and/or the originator of Internet content (e.g., a Webcast provider, etc.). Internet content source 517 may include Internet content in a variety of formats including, for example, HD, DVD, CD, ISO, AVI, MPG, and MOV. Internet content source 517, like media guidance data source 418, may include media guidance data that is helpful for a user to navigate among and locate desired Internet content selections.

Database server 514, together with repository 516, may store, manage, and retrieve Internet content. Repository 516 may be configured to collect and aggregate Internet content from Internet content source 517 and into one or more compilations (such as a catalog, an index, a database, etc.) for presentation of the aggregated Internet content to users. Repository 516 may be implemented using any multimedia database technology that supports video as a fundamental database object, such as VDBMS available from Purdue University. Repository 516 may be also be implemented using a relational database management system that supports an abstract data type.

Repository 516 may store Internet content in any one of several digital formats including, for example, MPEG formats. An MPEG-7 document, for example, uses XML-like video feature descriptions that represent and index video content for searching, which may be generated to facilitate video storage and query in repository 516. MPEG-7 is worldwide standard for multimedia content descriptors, which may include color descriptors, texture descriptors, shape descriptors, motion descriptors, spatial and temporal segmentation. The video binary data may be stored as external objects or as an external reference to the MPEG-7 XML documents. The video, including its feature descriptions and indices, may be stored in repository 516 along with other metadata, such as resolution for quality-of-service presentation, as compound document. Although the embodiments are described in terms of MPEG-7, those skilled in the art will appreciate that other multimedia content descriptors may be used without departing from the principles of the invention. It should also be understood that repository 516 may store Internet content in yet to be developed encoding formats.

Repository 516 may include one or more storage systems and may be either internal or external to web server 522 and/or database server 514. Additionally, those skilled in the art will appreciate that database server 514, Internet content repository 516, and web server 522 of FIG. 5 can be realized by separate computer systems, a network of computer processors and associated storage devices, a shared computer system or any combination thereof.

Application server 512 may relay request messages from broadcast infrastructures 560 and 570 to database server 514 via a web service 511. Application server 512 may be implemented using, for example, ASP.Net, though any comparable application server used as web service container may be used including, for example, Apache Tomcat, IBM Websphere and Oracle Application Server.

Application server 512 may also be configured to provide additional services. For example, application server 512 may provide user management services, including authentication functionality by comparing user identification information (e.g., user profiles) against stored values. User identification information may be stored, for example, on database server 514. Alternatively, user identification information may be managed by broadcast service provider 502 or by another third party provider.

Application server 512 may also provide device management, dashboard functionality, and recommendation services. A device management service may provide, for example, an interface to register a device to web service 511, such as user television equipment devices 402a or 402b. In some embodiments, the device management service can provide a link from the device to a corresponding user profile, such as a user profile stored in repository 516. A dashboard service may allow client applications (such as gateways 552a or 552b) to manage the configuration of a user's device dashboard. A recommendation service may provide any of the customization features described above in connection with a media guidance application including, for example, a set of Editorial Recommendation Lists to viewers, which may include popular programs available for viewing.

Web service 511 may allow web server 522 to interact with broadcast infrastructures 560 and 570 using XML-based messaging. The messages represent abstract descriptions of data being exchanged between gateways 552a and 552b and application server 512. In some embodiments, the messages may conform to a suitable transport protocol such as the Simple Object Access Protocol (SOAP). Web service 511 may include a BiM coder that encodes, for example, MPEG-7 data into BiM binary format using MPEG-7 extensions to the XML schema. BiM (Binary Format for MPEG-7) is a generic framework to facilitate the carrying and processing of MPEG-7 descriptions. BiM was designed to overcome a lack of efficiency of textural XML and to enable streaming and compression of XML documents. The data may then be wrapped into a SOAP envelope for transferring over Internet 550.

Broadcast network 510 may include one or more networks such as a cable television network, a terrestrial radio frequency link, or a satellite network using any broadcast format or protocol. On-demand network 590 may include one or more on-demand or private networks configured to deliver on-demand programs. Like broadcast network 510, on-demand network 590 may use any broadcast format or protocol. User television equipment 402a and 402b may be similar to user television equipment 402 described above.

Broadcast infrastructure 560 may include a television distribution facility, cable system headend, satellite distribution facility, broadcast programming sources, intermediate distribution facilities and/or servers, on-demand media servers, and other broadcast media content providers. Broadcast infrastructures 560 and 570 may include communications circuitry (e.g., a communications interface) similar to that described above in connection with FIG. 3. Communications circuitry may include multiple communications interfaces suitable for communicating with user equipment or other networks or servers. For example, broadcast infrastructures 560 and 570 may each include a communications interface for communicating with broadcast-based user equipment devices, such as user television equipment 402a and 402b and/or a communications interface for communicating with web servers, such as web server 522.

Paths 508a, 508b, 512a, and 512b are similar to paths 408, 410, and 412 described above in connection with FIG. 4, except that paths 508a, 508b, 512a, and 512b may not include an Internet communications path. Paths 528a, 528b, 526, 532, and 534 are similar to paths 408, 410, and 412 described above in connection with FIG. 4. Communications between all of the elements of system 500 may be exchanged over one or more communications paths, but are shown as a single path in FIG. 5 to avoid overcomplicating the drawing.

Web server 522, database server 514, Internet content repository 516, and gateways 552a and 552b may be implemented as specially configured information processing devices similar to those described in connection with user equipment device 300. Additionally, in some embodiments, gateway 552a may be implemented as an embedded system. Those skilled in the art will appreciate that there be more than one of each Internet content source 517, Internet content repository 516, database server 514, web server 522, and gateways 552a and 552b. In some embodiments, these elements may be combined, such as web server 522 and database server 514. Those skilled in the art will also appreciate that the system 500 may be configured differently to achieve maximum scalability.

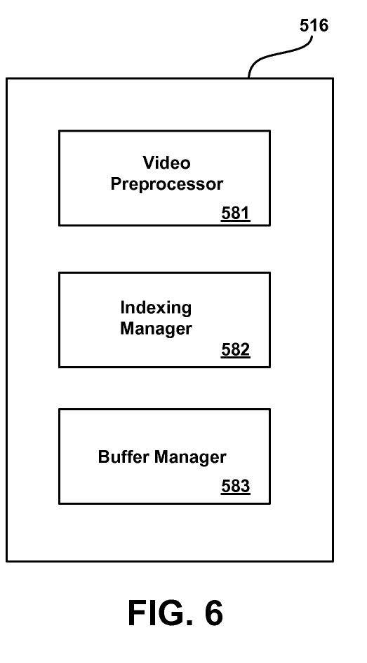

FIG. 6 is a schematic diagram that illustrates an exemplary embodiment of Internet content repository 516. Internet content repository 516 may include a video preprocessor 581, an indexing manager 582, and a buffer manager 583. Video preprocessor 581 may digitize and optionally compress videos received from Internet content source 517. Additionally, video preprocessor 581 may extract visual features (e.g., based on MPEG-7 descriptors), partition the video into meaningful shots by image and semantic processing, and/or generate and store content-based metadata with the video.

Indexing manager 582 may incorporate an index mechanism to facilitate searching and retrieval. For example, for an MPEG-7 document, an abstract data type (ADT), such as Vector ADT, may be used to represent high-dimensional visual feature fields. A high-dimensional index mechanism, such as a Generalized Search Tree general indexing structure, may be used to query the features efficiently.

Buffer manager 583 may provide segment allocation of the video data, rather than a traditional page-based approach. For example, buffer manager 583 may be configured according to underlying buffer management policies, MPEG-7 metadata, and/or semantic features. In operation, buffer manager 583 may divide the video data into segments and return the segments to application server 512 in series.

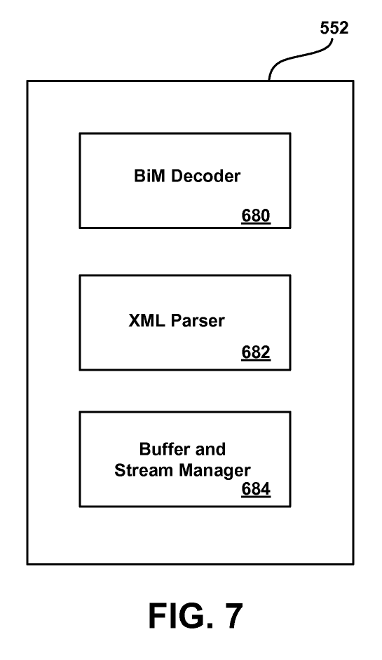

FIG. 7 is a schematic diagram of an exemplary embodiment of gateway 552 according to an embodiment. Instances of gateways 552a and 552b shown in FIG. 6 may each include a BiM decoder 680, an MPEG-7 XML parser 682, and a buffer and stream manager 684. BiM decoder 680 may decode BiM binary XML documents, extract visual features (e.g., based on MPEG-7 descriptions) and format it as a content-based XML document. MPEG-7 XML parser 682 may be configured to transform a video shot into a meaningful segment, such as by recovering the video shot from a video object, along with its metadata and visual and semantic descriptions. Buffer and stream manager 684 may use a shot segmentation scheme similar to the segmentation scheme implemented in Internet content repository 516, and group the shots into scenes, and then assemble the scenes as streamed videos. In one embodiment, gateways 552a and 552b may encode the stream into a broadcast signal. Gateway 552b, for example, may transfer the stream to user television equipment 402b via a specific transport protocol and, optionally, at a specific transfer rate.

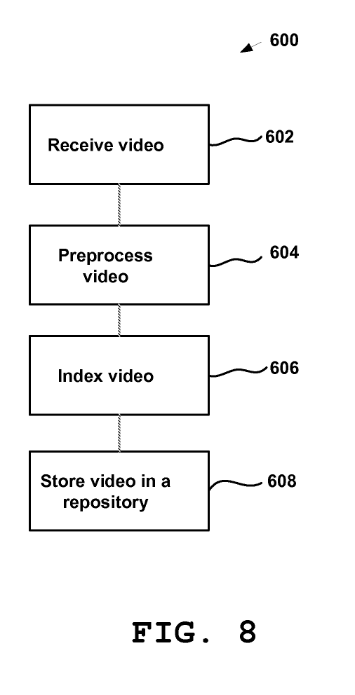

FIG. 8 is a process diagram of an exemplary method 600 for collecting and aggregating Internet content according to an embodiment of the invention. At block 602, Internet content may be received from an Internet content source, such as Internet content source 517. Block 602 may include bilateral communication between Internet content repository 516 and Internet content source 517 relating to, for example, the identification and nature and format of the Internet content to be received. In some embodiments, block 602 may be automated to collect new or updated Internet content from Internet content source 517. Communications between entities described with respect to the system 500, such as communication path 540 between Internet content source 517 and Internet content repository 516, are depicted as occurring electronically over a digital communications network but may also, or alternatively, occur via mail or in person.

At block 604, videos received at block 602 may be digitized and, optionally, compressed. Block 604 may also include extracting visual features, partitioning the video, and/or semantic processing. Block 605 may be implemented by video preprocessor 581.

At block 606, the videos preprocessed at block 604 may be indexed using, for example, a high dimensional index mechanism. Block 606 may be implemented by index manager 582.

At block 608, Internet content repository 516 may store the Internet content in any suitable format including, but not limited to, MPEG-7 format.

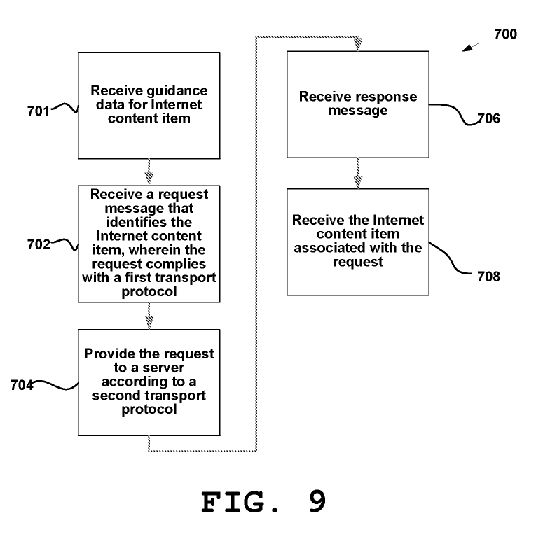

FIG. 9 is a process diagram of an exemplary method 700 for operating a broadcast video platform according to an embodiment of the invention. Method 700 will be described in terms of an interaction between broadcast infrastructure 560 and web service 511 but the method applies equally to interactions between web service 511 and broadcast infrastructure 570, even if infrastructure 570 uses a different software platform than infrastructure 560.

At block 701, guidance data associated with an Internet content item may be received, such as from application server 512. Guidance data may be presented to viewers in an electronic program guide (e.g., FIGS. 1 and 2). Listings associated with Internet content may be combined with listings associated with other programming. In some embodiments, Internet content listings may be presented as a separate category of listings in the electronic program guide (e.g., movies, sports, news, Internet video).

At block 702, a request may be received that identifies an Internet content item available from repository 516. The request may be associated with a user equipment device, such as user television equipment 402a. For example, the user may initiate the request by identifying an Internet content item (e.g., Internet content listing 118 of FIG. 1) by accessing an electronic program guide. Once initiated the request may traverse communication path 508a, broadcast network 510, and communication path 512a where it reaches broadcast service provider 502. In some embodiments, the request traverses communication path 508a, broadcast network 510a, and communication path 512a according to a transport protocol that may be native to broadcast infrastructure 560.

At block 704, the request message may be provided to web service 511 via communication path 528a according to a second transport protocol. For example, the request may be provided from broadcast service provider 502 to web service 511 over Internet 550, via communication paths 528a and 526, according to the http protocol. In some embodiments, the request may include an identifier for a user equipment device to which the requested Internet content item is associated, such as user television equipment 402a.

At block 706, a response message may be received in response to the request provided in block 704. For example, web service 511 may provide a response message to broadcast service provider 502, via gateway 552a. The response message may be a confirmation message, indicating whether or not the requested Internet content item is available. In some embodiments, broadcast service provider 502 may forward the response message to user television equipment 402a. Block 706 may also include receiving the Internet content item from web server 522.

Block 708 may include transferring, or facilitating a transfer, of at least a portion of the Internet content to broadcast service provider 502. In one embodiment, broadcast service provider 502a may buffer a sufficient amount of the Internet content received from web server 522 to render an uninterrupted presentation to the user. Gateway 552 may include a buffer manager that provides a similar function with respect to broadcast infrastructure 570. In one particular example, broadcast service provider 502 may be configured to buffer popular Internet content even before receiving a user request. The buffer may include non-volatile storage, volatile storage, or both.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

One of ordinary skill in the art should appreciate that the invention may take the form of an entirely hardware embodiment or an embodiment containing both hardware and software elements. In particular embodiments, such as those embodiments that relate to methods, the invention may be implemented in software including, but not limited to, firmware, resident software, and microcode.

It will be appreciated that while the discussion of media content has focused on video content, the principles of media guidance can be applied to other types of media content, such as music, images, etc.

1. A broadcast video platform comprising:
a first communications interface coupled to a broadcast-based user equipment device, wherein the communications interface is configured to receive a request for a video item from the user equipment device according to a first transport protocol;
a second communications interface coupled to a server, wherein the second communications interface is configured to provide to the server the request according to a second transport protocol, and wherein the second communications interface is configured to receive the video item from the server in a binary format; and
a decoder for decoding the video item.

2. The broadcast video platform of claim 1, further comprising an encoder for encoding the video item into a broadcast signal.

3. The broadcast video platform of claim 1, wherein the decoder is configured to decode a BiM binary XML document.

4. The broadcast video platform of claim 1, wherein the second transport protocol is http.

5. The broadcast video platform of claim 1, wherein the request according to the second transport protocol is expressed as an XML listing in a SOAP envelope.

6. The broadcast video platform of claim 5, wherein the SOAP envelope includes a header section and a body section, and wherein the body section includes an identifier corresponding to the user equipment device.

7. The broadcast video platform of claim 1, wherein the second communications interface is configured to receive a response message from the server.

8. The broadcast video platform of claim 1 further comprising a memory for storing at least a portion of the video item.

9. The broadcast video platform of claim 1 further comprising a processor and a storage device connected to the processor, and wherein the instructions when executed by the processor comprise uncompressing the video item.

10. The broadcast video platform of claim 1 further comprising a buffer manager for dividing the video item into segments.

11. The broadcast video platform of claim 1, wherein the video item comprises Internet content.

12. A server comprising:
a processor;
a storage device connected to the processor, wherein the storage device is encoded with instructions, and wherein the instructions when executed by the processor comprise:
receive a request for a video item, wherein the request is expressed as an XML listing in a SOAP envelope, wherein the SOAP envelope includes a header section and a body section, and wherein the body section includes an identifier corresponding to a user equipment device used to request the video item; and
receive the video item;
encode the video item into a binary format; and
transmit the video item in a SOAP envelope.

13. A content management system comprising:
a content repository configured to store a video item;
a server configured to receive a request for the video item, and wherein the server is configured to respond to a request for the video item from a requesting entity;
a buffer manager configured to segment the video item based on a buffer management policy that corresponds to a second buffer management policy associated with the requesting entity; and
a web service module configured to facilitate communication between the requesting entity and the server.

14. The system of claim 13 wherein the server includes an application server and a database server, wherein the database server is coupled to the content repository.

15. The system of claim 13 wherein the web service module protocol is SOAP, and wherein the request is expressed as an XML listing in a SOAP envelope having a header section and a body section.

16. The system of claim 13 further comprising a media guidance module configured to provide program information to the requesting entity, wherein the program information includes program information about Internet content.

17. The system of claim 13 wherein the requesting entity is a gateway.

18. A system comprising:
a processor;
a storage device connected to the processor, wherein the storage device is encoded with instructions, and wherein the instructions when executed by the processor comprise:
rendering a plurality of program listings for display to a user, wherein the program listings include a broadcast content item and an Internet content item; and
receiving a request for the Internet content item, wherein the request conforms to the SOAP protocol.

19. A method comprising:
receiving a request for a video item from the user equipment device according to a first transport protocol;
providing the request to a server according to a second transport protocol;
receiving the video item from the server in a binary format; and
decoding the video item.

20. The method of claim 19, further comprising encoding the video item into a broadcast signal.

21. The method of claim 19, wherein decoding includes decoding a BiM binary XML document.

22. The method of claim 19, wherein the second transport protocol is http.

23. The method of claim 19, wherein the request according to the second transport protocol is expressed as an XML listing in a SOAP envelope.

24. The method of claim 23, wherein the SOAP envelope includes a header section and a body section, and wherein the body section includes an identifier corresponding to the user equipment device.

25. The method of claim 19, further comprising receiving a response message.

26. The method of claim 19 further comprising storing at least a portion of the video item.

27. The method of claim 19 further comprising uncompressing the video item.

28. The method of claim 19 further comprising dividing the video item into segments.

29. The method of claim 19 wherein the video item comprises Internet content.

30-40. (canceled)
